(19) United States
(12) Patent Application Publication
(10) Pub. No.: US 2026/0332407 A1
(43) Pub. Date: Oct. 22, 2026

(54) SECURITY USING ARTIFICIAL INTELLIGENCE MODELS FOR ADVANCED DIGITAL WATERMARKING

(71) Applicant: Kyndryl, Inc., New York, NY (US)

(72) Inventors: Li Long Chen, Beijing (CN); Manish Mitruka, Pune (IN); Cesar Augusto Rodriguez Bravo, Alajuela (CR); Omar Odibat, Cedar Park, TX (US)

(21) Appl. No.: 19/185,374

(22) Filed: Apr. 22, 2025

(51) Int. Cl. H04L 9/08

(52) U.S. Cl. CPC H04L 9/088; H04L 9/0861

(57) ABSTRACT

Embodiments relate to providing AI powered document security using AI models for advanced digital watermarking. A technique includes generating a synonym table associated with a subject matter related to an original electronic document and generating a watermark key from the synonym table in accordance with the subject matter related to the original electronic document, the watermark key comprising a subset of the synonym table. The technique includes inputting, to an AI model, the watermark key, the original electronic document, and a request to generate a watermark electronic document using at least a portion of the watermark key. The technique includes electronically transmitting the watermark electronic document, wherein an authenticity of the watermark electronic document is secured based on the watermark key.

### BACKGROUND

The present invention generally relates to computer systems, and more specifically, to computer-implemented methods, computer systems, and computer program products configured and arranged for providing artificial intelligence (AI) powered document security using generative AI models for advanced digital watermarking.

Document security, tracking, and authenticity refers to the practices and technologies used to ensure a document is genuine, has not been tampered with, can be traced throughout its lifecycle, and is only accessible to authorized individuals This may often be achieved through methods like digital signatures, watermarks, and access control mechanisms to prevent fraud and maintain data integrity across digital documents.

Security software is designed to protect, secure, and track documents (e.g., digital data). Security software can protect data and organizations from a wide range of risks. Various data security controls can be utilized to protect data, which can include policies, procedures, and mechanisms.

### SUMMARY

Embodiments of the present invention are directed to computer-implemented methods for providing artificial intelligence (AI) powered document security using generative AI models for advanced digital watermarking. A non-limiting computer-implemented method includes generating a synonym table associated with a subject matter related to an original electronic document. The method includes generating a watermark key from the synonym table in accordance with the subject matter related to the original electronic document, the watermark key including a subset of the synonym table. The method includes inputting, to an AI model, the watermark key, the original electronic document, and a request to generate a watermark electronic document using at least a portion of the watermark key. The method includes electronically transmitting the watermark electronic document, where an authenticity of the watermark electronic document is secured based on the watermark key.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments;

FIG. 2 depicts a block diagram of an example system configured to dynamically provide an artificial intelligence (AI) powered document security using generative AI models for advanced digital watermarking according to one or more embodiments;

FIGS. 3 and 4 depict flowcharts of computer-implemented methods for providing AI powered document security using AI models for advanced digital watermarking and providing document security actions according to one or more embodiments;

FIG. 5 depicts a block diagram of an example of adding a watermark to the original electronic document according to one or more embodiments;

FIGS. 6A and 6B depict block diagrams of a successful case and unsuccessful case of verifying the authenticity of a watermark electronic document according to one or more embodiments;

FIGS. 7A and 7B depict an example of embedding subscriber identification information in a watermark electronic document according to one or more embodiments;

FIGS. 8A, 8B, and 8C depict an example of dual watermarks and verifications according to one or more embodiments;

FIGS. 9 and 10 depict an example of constructing a synonym table and generating a watermark key according to one or more embodiments;

FIG. 11 is a flowchart of a computer-implemented method according to one or more embodiments;

FIG. 12 depicts a cloud computing environment according to one or more embodiments; and

FIG. 13 depicts abstraction model layers according to one or more embodiments.

### DETAILED DESCRIPTION

One or more embodiments are configured and arranged to provide electronic document security and more particularly to artificial intelligence (AI) powered document security using generative AI models for advanced digital watermarking. The present disclosure provides a technical solution that leverages a digital watermarking system using a synonym table tailored for specific industries or companies. The process involves defining a watermark key and applying watermark key to prepared text using synonym substitution via an AI model such as a large language model (LLM) to verify the text's origination. Additionally, a unique subscriber identification (ID) can be embedded in the watermark electronic document to detect unauthorized use of the text. The watermark text is then distributed to subscribers, and a digital watermark validator tracks and verifies text usage, ensuring secure and traceable content dissemination while maintaining contextual and industry-specific language consistency.

Global technical services face growing challenges in protecting and ensuring content authenticity as electronic documents are widely shared through various mediums. Traditional protection methods often fall short, making it important to develop a robust solution for watermarking, verifying, and tracking text documents to control proprietary information and enforce regulatory compliance. Existing solutions for protecting text documents, such as digital rights management (DRM), blockchain-based tracking, and content encryption, present several limitations:
1) Complexity and Overhead: many existing solutions, like blockchain, introduce significant complexity and computational overhead, making them impractical for widespread adoption in fast-paced environments. The need for extensive infrastructure and resources can be prohibitive for organizations looking to implement these solutions at scale.
2) Lack of Flexibility: traditional DRM systems often lack the flexibility to handle the dynamic nature of text documents, especially in scenarios where content needs to be modified, versioned, and/or shared across different platforms. This inflexibility can hinder collaboration and limit the utility of the content.
3) Inadequate Traceability: while encryption and other security measures can protect content from unauthorized access, they often fail to provide a reliable mechanism for tracing the distribution and origin of the text. This limitation makes it difficult to identify the source of unauthorized leaks or misuse.
4) User Experience Impact: many existing solutions impose restrictions or alter the user experience, such as limiting access or requiring special software to view the content. These restrictions can lead to user frustration and decreased productivity, especially in collaborative environments.

A digital watermark is a covert marker embedded in mediums such as audio, video, images, and/or text, primarily employed to prove ownership and ensure content authenticity, which prevent unauthorized use and distribution. In an example scenario, an organization is a global leader in technical services and has developed a whitepaper authored by its data scientists focused on enhancing cloud security and resilience. This valuable document is shared with several clients who rely on its insights to strengthen their operations, for example, based on some security agreement with the organization. To protect its intellectual property, the organization desires to prove ownership of the whitepaper, while the clients require assurance of the document's provenance or origination. If the organization detects unauthorized use or distribution of the whitepaper, it must quickly identify which client is responsible for the breach, ensuring that the integrity and confidentiality of its intellectual property are maintained.

According to one or more embodiments, a novel approach is to securely provide watermark text documents with flexibility and seamless workflow integration, achieved through a lightweight, context-aware solution using synonym substitution and subscriber identification (ID) embedding to ensure authenticity and traceability. One or more embodiments provide techniques to drive a robust system for watermarking and tracking digital content in various scenarios. One or more embodiments can address any one or more of the following scenarios including proving text document origination, detecting unauthorized distribution, licensing enforcement, version control and document management, and regulatory compliance applications.
Proving Text Document Origination: one or more embodiments are configured to ensure that the origin of an electronic document can be verified in environments where content authenticity is paramount, such as research, proceedings, and intellectual property disputes.
Detecting Unauthorized Distribution: as content sharing becomes more prevalent, one or more embodiments are configured to protect proprietary information and track unauthorized dissemination thereby maintaining control over sensitive data.
Licensing Enforcement: one or more embodiments are configured to properly enforce licensing measures through embedded watermarks, which help organizations ensure compliance.
Version Control and Document Management: in collaborative settings, one or more embodiments are configured to maintain accurate records of document versions and changes, which prevents discrepancies and ensures consistent communication.
Regulatory Compliance Applications: one or more embodiments are configured to provide watermarking and tracking which can facilitate meeting regulatory requirements, thereby providing a method for auditing document usage and proving compliance.

One or more embodiments described herein can utilize machine learning techniques to perform tasks, such as classifying a feature of interest. More specifically, one or more embodiments described herein can incorporate and utilize role-based decision making and artificial intelligence (AI) reasoning to accomplish the various operations described herein, namely classifying a feature of interest. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” “a trained classifier,” and/or “trained machine learning model”) can be used for classifying a feature of interest, for example. In one or more embodiments, machine learning functionality can be implemented using an Artificial Neural Network (ANN) having the capability to be trained to perform a function. In machine learning and cognitive science, ANNs are a family of statistical learning models inspired by neural networks in nature. ANNs can be used to estimate or approximate systems and functions that depend on a large number of inputs. Convolutional Neural Networks (CNN) are a class of deep, feed-forward ANNs that are particularly useful at tasks such as, but not limited to analyzing visual imagery and natural language processing (NLP). Recurrent Neural Networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

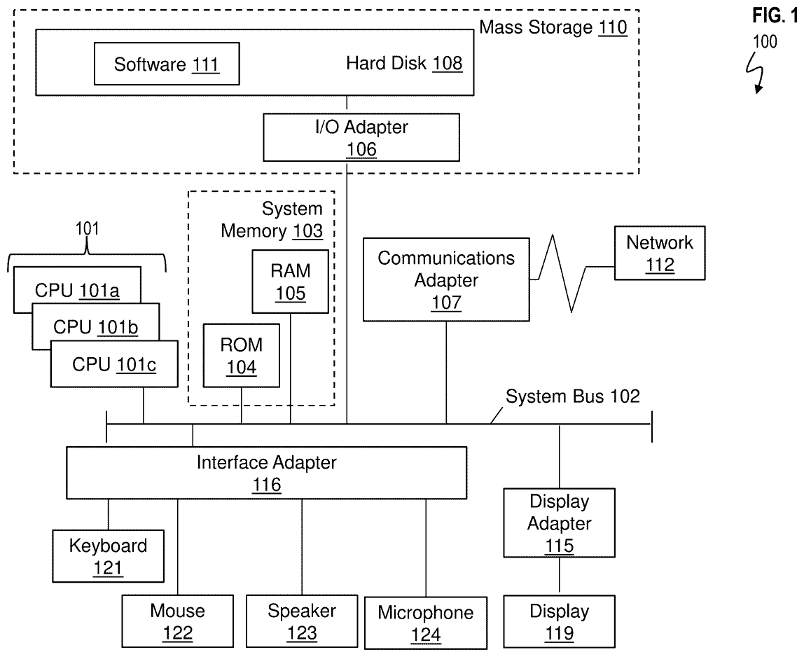

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction are discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

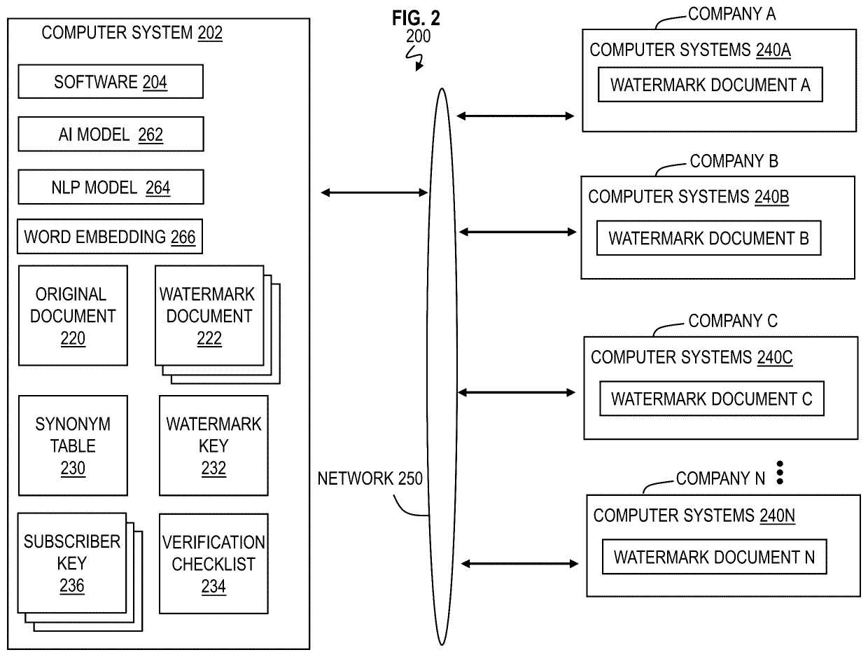

FIG. 2 depicts a block diagram of an example system 200 configured to provide AI powered document security using generative AI models for advanced digital watermarking according to one or more embodiments. The present disclosure provides a context-aware solution using synonym substitution and subscriber identification (ID) embedding to ensure authenticity and traceability of the electronic document.

The system 200 includes a computer system 202 configured to communicate over a network 250 with many different computer systems, such as a computer system 240A, a computer system 240B, a computer system 240C, through a computer system 240N. The computer system 240A, the computer system 240B, the computer system 240C, through the computer system 240N can generally be referred to as computer systems 240. In one or more embodiments, the computer systems 240 may represent computer systems of company A, company B, company C, through company N.

The computer systems 240 can include or be representative of servers of one or more companies. The computer systems 240 can include user devices which can be personal computers or laptops. The user devices can be a mobile device such as a cellular phone or tablet, or a smart device. A smart device is an electronic device, generally connected to other devices or networks via different wireless protocols that can operate to some extent interactively. Several notable types of smart devices are smartphones, smart speakers, tablets, smartwatches, smart bands, smart glasses, and many others.

The network 250 can be a wired and/or wireless communication network, and the communication network includes a telecommunications network, the public switched telephone network (PTSN), voice over IP (VOIP) network, etc. The communication network includes cellular networks, satellite networks, etc.

The computer systems 240 can include various software and hardware components including software applications (apps) for communicating over the network 250 as understood by one of ordinary skill in the art. The software applications may provide users with a way to access information, services, entertainment, etc. The computer systems 240 can include various software and hardware components designed to perform specific functions as discussed herein.

The computer system 202, computer systems 240 (e.g., user devices, servers, etc.), software 204, artificial intelligence (AI) model 262, NPL model 264, word embedding model 266, etc., can include functionality and features of the computer system 100 in FIG. 1 including various hardware components and various software applications such as software 111 which can be executed as instructions on one or more processors 101 in order to perform actions according to one or more embodiments of the invention. The software 204 can include, be integrated with, and/or call other pieces of software, algorithms, application programming interfaces (APIs), graphical user interfaces (GUIs) etc., to operate as discussed herein.

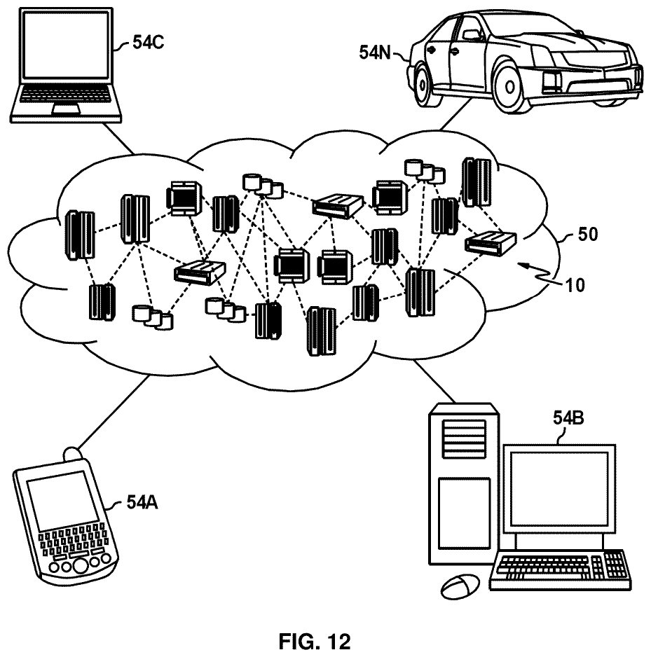

The computer system 202 may be representative of numerous computer systems and/or distributed computer systems configured to provide watermark services for electronic documents on the computer systems 240. The computer system 202 can be part of a cloud computing environment such as a cloud computing environment 50 depicted in FIG. 12, as discussed further herein.

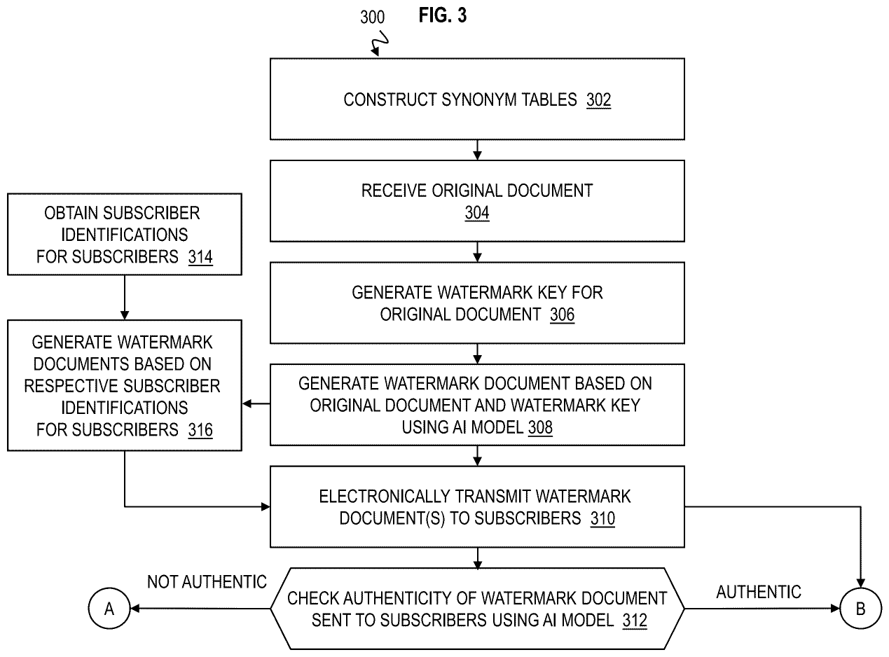

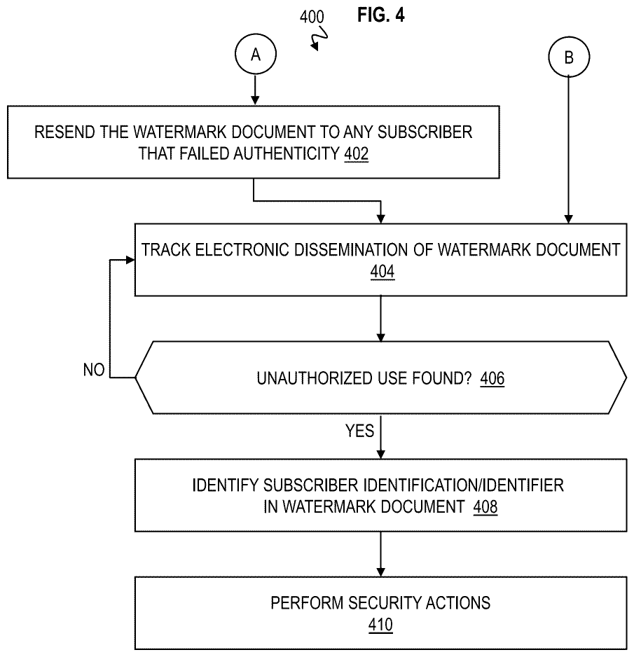

As will be seen below, FIGS. 3 and 4 depicts flowcharts of computer-implemented methods 300 and 400 for providing AI powered document security using generative AI models for advanced digital watermarking and providing document security actions based on the lack of authenticity and/or improper dissemination of the watermark documents, according to one or more embodiments. According to one or more embodiments, the digital watermarking and document security actions can be for an organization that has an electronic document to protect and track such that the watermark document can be transmitted to subscribers. In one or more embodiments, digital watermarking and document security actions can be performed on behalf of one or more companies to protect their electronic documents.

Referring to FIG. 3, at block 302, the software 204 of the computer system 202 is configured to cause construction of one or more synonym tables 230 and/or receive the synonym table 230. The synonym table 230 may correspond to a specific industry for an organization and includes synonyms of terms, phrases, etc., particular to that industry. The synonym table 230 can be for an industry in automotive technology, artificial intelligence, healthcare, robotics, manufacturing, etc.

At block 304, the software 204 of the computer system 202 is configured to receive an original electronic document 220. The electronic document 220 includes text, and some aspect of the text can be related to the industry. In one or more embodiments, the electronic document 220 is the document that the organization wishes to be transformed into a watermark document.

At block 306, the software 204 of the computer system 202 is configured to generate a watermark key 232 for the original electronic document 220. The software 204 can generate the watermark key 232 as a subset of the synonym table 230. In one or more embodiments, the software 204 may receive a topic of the original electronic document 220 and select the subset of the synonyms in the synonym table 230 to be the watermark key 232 based on selecting synonyms that are likely related to the original electronic document 220. In one or more embodiments, the software 204 can employ the NLP model 264 to obtain the topic of the original electronic document 220. In one or more embodiments, the software 204 can employ the NLP model 264 to select the subset of synonyms in the synonym table 230 that are likely related to the topic of the original electronic document 220.

At block 308, the software 204 of the computer system 202 is configured to generate a watermark electronic document 222 of the original electronic document 220. In one or more embodiments, the software 204 can input the original electronic document 220, the watermark key 232, and a request to the AI model 262 with instructions to replace text in the original electronic document 220 with synonyms in the watermark key 232 in order to create the watermark electronic document 222 and create a verification checklist 234. The request is a prompt for the AI model 262. In some cases, the instructions may request that there are two, three, four, five, etc., replacements of text in the original electronic document 220 with synonyms the watermark key 232. In one or more embodiments, the instructions can require the AI model 262 to identify the replaced text and/or location of the replaced text in the watermark electronic document 222. In one or more embodiments, the instructions can require the AI model 262 to identify the synonyms used in the watermark key 232 and indicate what text was replaced in the original electronic document 220 with the respective synonyms, in order to create the verification checklist 234.

At block 310, the software 204 of the computer system 202 is configured to send, transmit, upload, etc., the watermark electronic document 222 to one or more computer systems 240. The recipients of the watermark electronic document 222 can be subscribers. In an example scenario, the watermark electronic document 222 can contain important information received by computer system 240 of a company, and the authenticity of the received watermark electronic document 222 needs to be verified by the computer system 240 before proceeding forward. The computer system 240 can transmit, send, and/or upload the watermark electronic document 222 to the computer system 202 and request verification. The computer system 240 can upload the watermark electronic document 222 to a website or portal for verification. In one or more embodiments, watermark electronic documents 222 can be embedded with subscriber identifications/identifiers unique to each recipient, such that each recipient receives its unique version of the watermark electronic documents 222 with its own subscriber identification embedded therein. For example, one recipient may receive watermark electronic document A with subscriber identification A, another recipient may receive watermark electronic document B with subscriber identification B, a recipient may receive watermark electronic document C with subscriber identification C, and so forth.

At block 312, in response to receiving the request for verification from any of the computer systems 240, the software 204 of the computer system 202 is configured to check the authenticity of the received watermark electronic document 222. In one or more embodiments, the software 204 can input the watermark electronic document 222 received from the computer system 240, the verification checklist 234 associated with the watermark electronic document 222, and a request to the AI model 262 with instructions to verify that the replacements in the verification checklist 234 are present in the watermark electronic document 222 in order to output whether the watermark electronic document 222 is authentic or not inauthentic. In one or more embodiments, the software 204 may perform the verification/validation by comparing the verification checklist 234 against the received watermark electronic document 222.

There are further security options according to one or more embodiments. Additionally, in one or more embodiments, at block 314, the software 204 of the computer system 202 is configured to obtain/receive subscriber identifications (IDs) for subscribers. The subscribers can be representative of companies of the computer systems 240 including, for example, computer system 240A of company A, computer system 240B of company B, through computer system 240N company N. Each subscriber has a unique identification/identifier, which may be a number, an alphanumeric value, etc., that identifies the subscriber.

At block 316, the software 204 of the computer system 202 is configured to further generate watermark electronic documents 222 based on the respective subscriber identifications for the subscribers. In one or more embodiments, the respective subscriber identifications are uniquely embedded into each of the watermark electronic documents 222 using a subscriber key 236 such that each subscriber can receive its own watermark electronic document 222 having its subscriber identification therein.

In one or more embodiments, there can be a master subscriber key 236 utilized to uniquely identify each of the subscribers based on a unique substitution for each of the subscribers. In the master subscriber key 236, each subscriber identification can be mapped to a unique substitution of text in the watermark electronic document 222 with synonyms obtained from the synonym table 230. For a given subscriber, the software 204 can replace text in the watermark electronic document 222 with synonyms in accordance with a mapping for the unique subscriber identification in the master subscriber key 236.

In one or more embodiments, the respective subscriber identifications are uniquely embedded into each of the watermark electronic documents 222 using respective subscriber keys 236 specific to each subscriber such that each subscriber can receive its own watermark electronic document 222 having its subscriber identification therein. For example, company A has its subscriber identification A, company B has its subscriber identification B, company C has its subscriber identification C, and so forth. Company A has its unique subscriber key 236 subscriber identification A, company B has its unique subscriber key 236 subscriber identification B, company C has its unique subscriber key 236 subscriber identification C, and so forth. Taking company A as an example, the software 204 can replace text in the watermark electronic document 222 with synonyms in accordance with the key that maps to the subscriber identification A such that this version of the watermark electronic document 222 is embedded with the subscriber identification A. The versions of the watermark electronic documents 222 are each embedded with the subscriber identifications A, B, C, and N respectively for companies A, B, C, and N.

Referring to FIG. 4, at block 402, when the watermark document sent to a subscriber is determined not to be authentic, the software 204 of the computer system 202 is configured to resend the watermark electronic document 222 to any subscribers having electronic documents that failed the validation test for authenticity. Additionally, the software 204 of the computer system 202 is configured to send an invalidation notification to the computer system of the subscriber indicating that the watermark electronic document 222 is not authentic.

At block 404, when the watermark document sent to a subscriber is determined to be authentic, the software 204 of the computer system 202 is configured to track the electronic dissemination of the watermark electronic document 222. Any suitable technique may be utilized to track the watermark electronic document 222 and revoke user access to the watermark electronic document 222 as deemed appropriate. In one or more embodiments, the software 204 may search one or more websites, one or more computer systems (e.g., servers of companies, servers of the Internet, etc.), the particular websites associated with the subscribers/recipients of the watermark electronic document 222, social media sites including blogs and posts, etc.

At block 406, the software 204 of the computer system 202 is configured to check whether unauthorized use of the watermark electronic document 222 is found. If not found, flow returns to block 404.

At block 408, (optionally when a subscriber identification is present) when unauthorized use of the watermark electronic document 222 is found, the software 204 of the computer system 202 is configured to identify the subscriber identification/identifier in the watermark electronic document 222 for the particular subscriber. The software 204 may search the watermark electronic document 222 for replacements of text that map back to the subscriber key 236 and identify the unique subscriber identification of a subscriber.

At block 410, the software 204 of the computer system 202 is configured to cause one or more security actions to be executed. For explanation purposes, an example scenario is presented in which the subscriber identification A for company A has been found as the unique subscriber identification in the watermark electronic document 222. As such, the software 204 can cause a notification to be transmitted to the computer system 240A of company A instructing company A to remove or take down the unauthorized publication of the watermark electronic document 222. When the unauthorized publication of the watermark electronic document 222 is presented on a webpage of a server (such as a computer system), the software 204 can cause a comment, remark, rebuttal, etc., to be published on the same webpage as the unauthorized publication of the watermark electronic document 222, which indicates that the document should not be relied upon and its use is unauthorized. The software 204 can communicate with a host provider of the webpage of a server and request that the unauthorized use of the watermark electronic document 222 be stopped and document be removed. The software 204 can quarantine the watermark electronic document 222 such that it is not accessible. In some cases, the watermark electronic document 222 can have digital rights management, and the software 204 can revoke access to the watermark electronic document 222 by encrypting the document. The watermark electronic document 222 may contain executable scripts that require a user to request access from the compute system 202 before viewing, and the software 204 can cause this request to be denied.

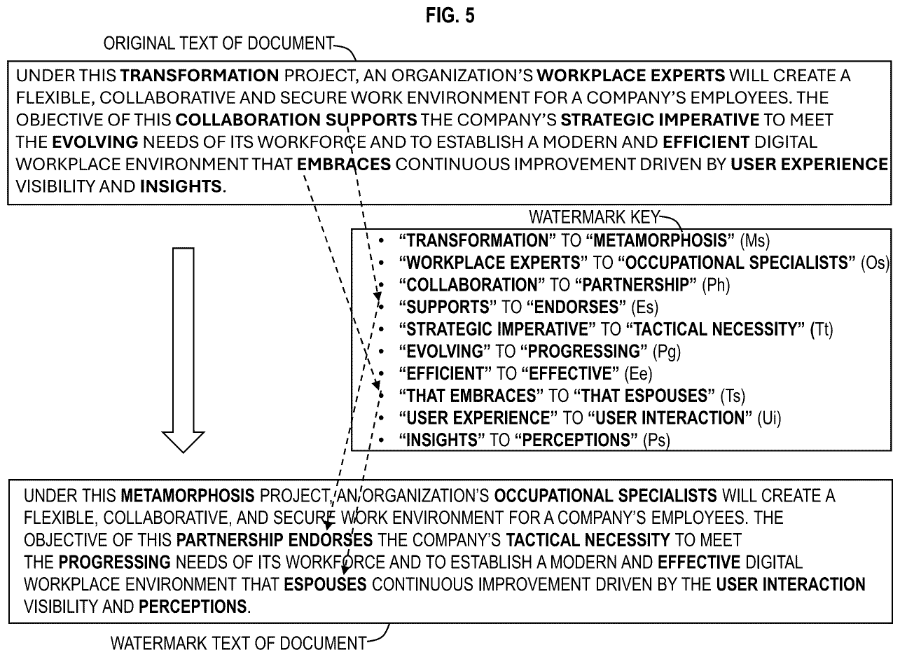

FIG. 5 depicts a block diagram of an example of adding a watermark to the original electronic document. As can be seen, certain text has been identified in bold in the original electronic document, and the text is to be replaced with synonyms from the watermark key. As an example, it can be seen that the text “supports” and “embraces” in the original electronic document have been replaced with the synonyms “endorses” and “espouses” respectively in the watermark electronic document. The watermark key was used to make this substitution, along with other substitutions, thereby generating the watermark electronic document from the original electronic document.

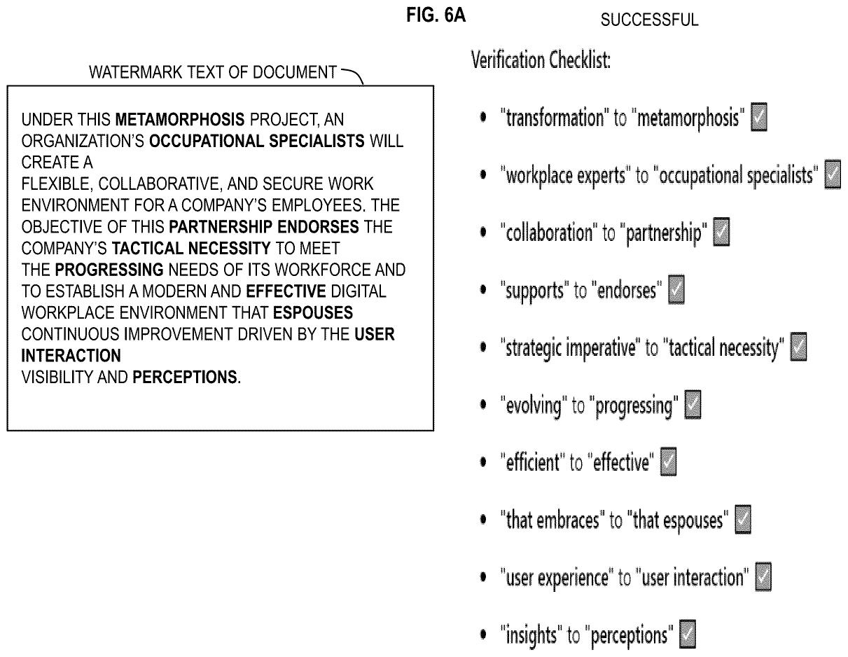

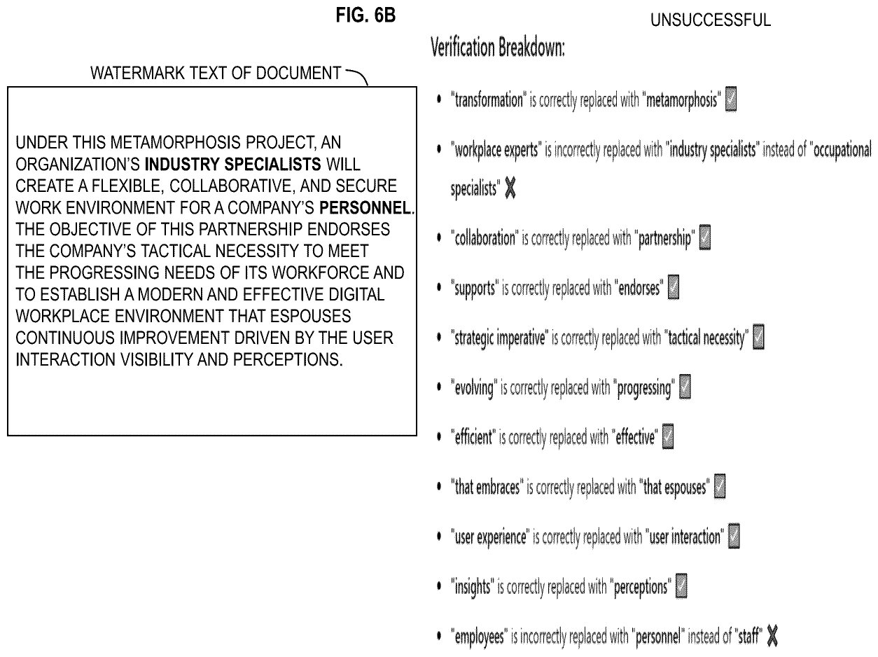

FIG. 6A depicts a block diagram of a successful case of verifying the authenticity of the watermark electronic document. A verification checklist (e.g., verification checklist 234) can be utilized to verify that the text of the original electronic document 220 has been properly replaced with the synonyms of the watermark key 232. Each location of the synonyms is verified in the watermark electronic document 222, thereby determining that the authenticity of the watermark electronic document is true. In one or more embodiments, a verification checklist can be created to assist with verifying the authenticity of the watermark electronic document. In one or more embodiments, the watermark key of synonyms can be utilized as the verification checklist for verifying the authenticity of the watermark electronic document.

FIG. 6B depicts a block diagram of an unsuccessful case of attempting to verify the authenticity of the watermark electronic document. In this example, the watermark electronic document 222 fails the validation and is therefore not authentic. As can be seen, “workplace experts” is incorrectly replaced with “industry specialists” instead of “occupational specialists.” Additionally, “employees” is incorrectly replaced with “personnel” instead of “staff.” Accordingly, this watermark electronic document 222 is deemed not to be authentic and security action can be executed in addition to resending the watermark electronic document to any subscriber with an inauthentic version.

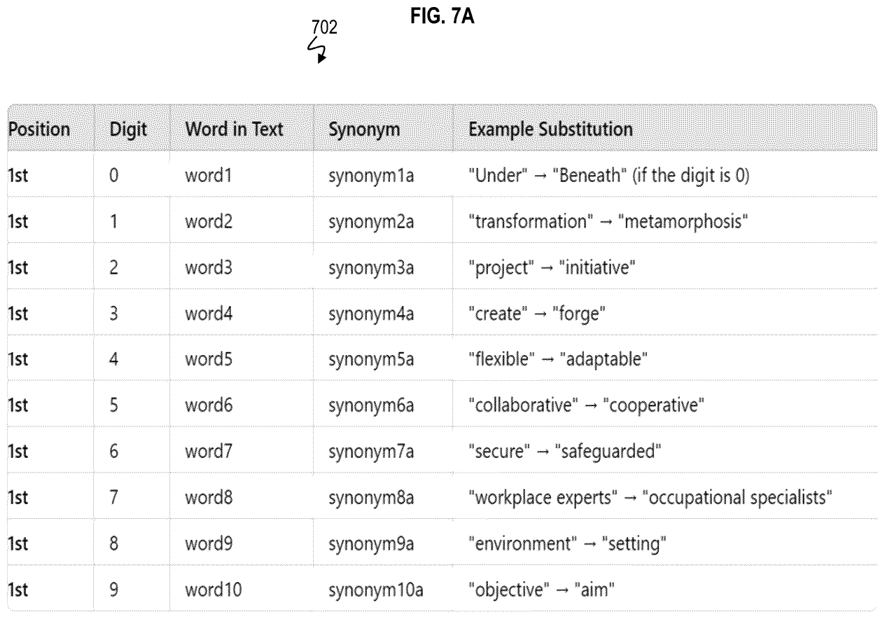

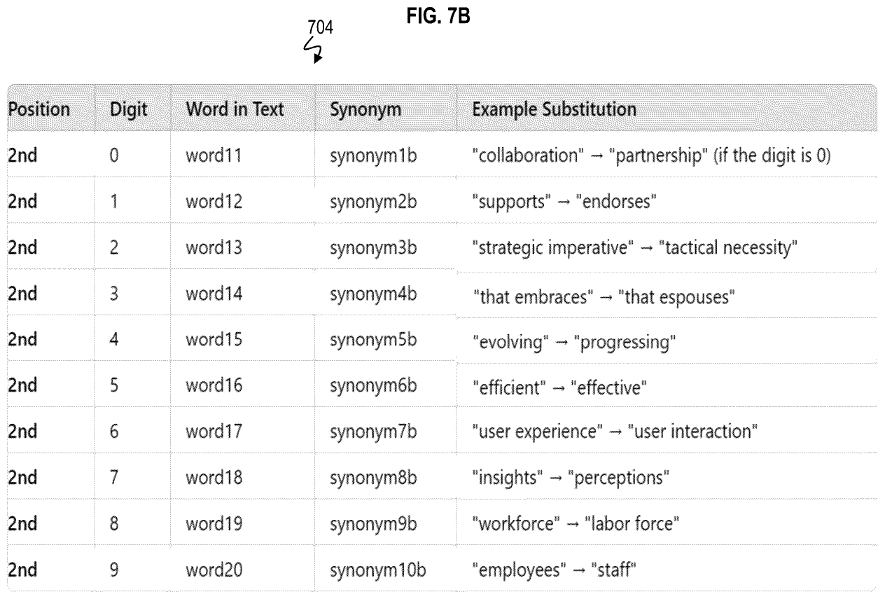

FIGS. 7A and 7B depict an example of embedding subscriber identification information in a watermark electronic document according to one or more embodiments. The encoding is to embed the subscriber information in order to trace the version of the watermark document back to the particular subscriber. The example illustrates position-based encoding for a 2-digit subscriber identification denoting the subscriber. Although the 2-digit subscriber identification is shown as an example, it should be appreciated that a 3-digit, 4-digit, 5-digit, 6-digit, etc., subscriber identification can be utilized in one or more embodiments.

Tables 702 and 704 may be part of the subscriber key 236. In this encoding example, the subscriber identification is “35” for a given subscriber such as, for example, company A. There are two positions in which the first position is for “3” and the second position is for “5.” In table 702, the various values for the first positions are shown, while table 704 shows the different values for second positions. To encode a watermark electronic document 222 with the subscriber identification “35,” the first position for “3” is encoded by substituting “create” with the synonym “forge,” and the second position for “5” is encoded by substituting “efficient” with the synonym “effective.” As can be seen, the tables 702 and 704 display the position, digit, word in text which is the location of the word being replaced in the original electronic document, the synonym which is selected from the synonym table, and the example substitution that denotes the replacement of the text with the synonym.

The decoding is to determine for which subscriber the watermark electronic document belongs. When decoding the text of the watermark electronic document, the software 204 identifies the substituted words in the example substitution in the watermark electronic document, finds the position and digit associated with the found substitutions, and combines the digits according to their positions to reconstruct the subscriber identification “35.” As can be seen, the subscriber key is utilized to trace each version of the watermark electronic document back its unique subscriber.

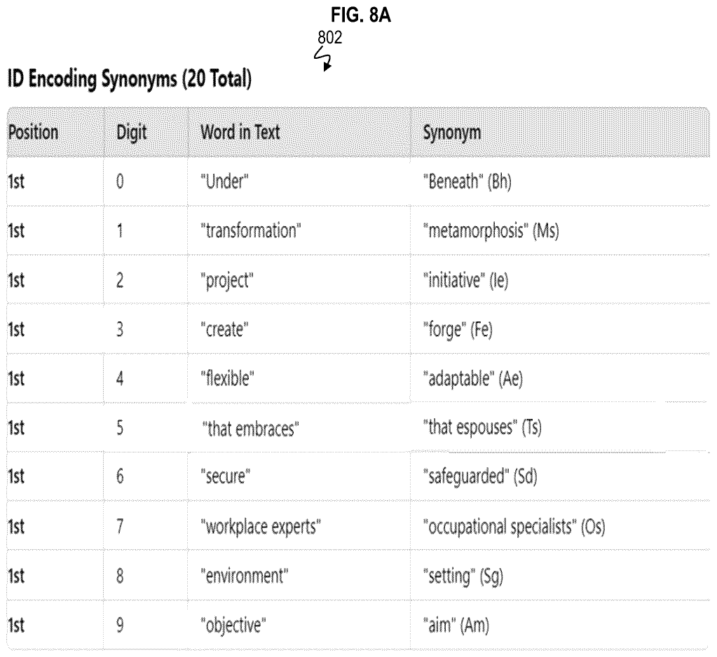

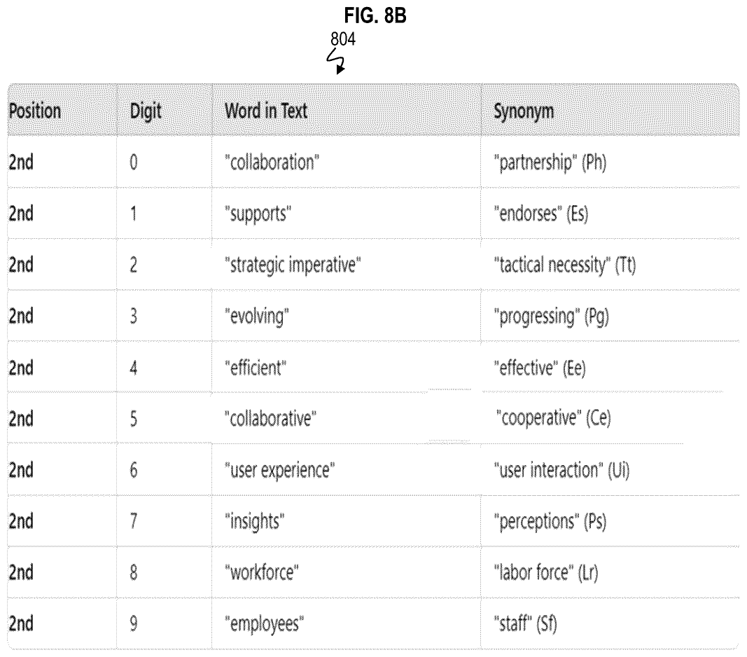

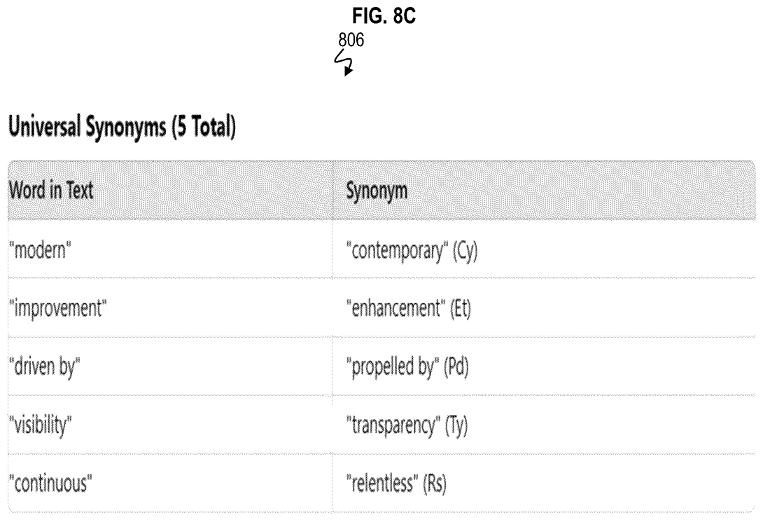

FIGS. 8A, 8B, and 8C depict an example of dual watermarks and verifications according to one or more embodiments. Tables 802 and 804 include 20 synonyms used to encode a 2-digit subscriber identification. Each digit in the subscriber identification corresponds to a specific word in the text, which is then substituted with the associated synonym. Table 806 includes 5 universal synonyms that are consistently applied across all text in the watermark electronic document to verify authenticity. This setup allows for both the embedding of subscriber identification and the verification of text authenticity, providing a robust watermarking solution.

Tables 802 and 804 can be utilized to encode the subscriber identification for different subscribers each having a unique subscriber identification. The subscriber identification encoding is unique to each subscriber such as, for example, company A, company B, company C, and so forth. During the subscriber identification encoding of subscriber identification “35,” the first digit is “3” encoded by substituting “create” with the synonym “forge,” and the second digit is “5” encoded by substituting “collaborative” with the synonym “cooperative.”

Table 806 is utilized for the universal synonym encoding of all watermark electronic documents regarding of the subscriber. In table 806, “modern” is substituted with the synonym “contemporary,” “improvement” is substituted with the synonym “enhancement,” “driven by” is substituted with the synonym “propelled by,” “visibility” is substituted with the synonym “transparency,” and “continuous” is substituted with the synonym “relentless.”

To the decode the subscriber identification “35” in the watermark electronic document, the software 204 identifies the substituted words and reconstructs the subscriber identification “35.” When identifying the substituted words, because “create” is substituted with “forge,” this corresponds to the digit “3” in the first position in the subscriber key as depicted in FIG. 8A. Because “collaborative” is substituted with “cooperative,” this corresponds to the digit “5” in the second position in the subscriber key in FIG. 8B. During the reconstruction, the identified substitutions “forge” and “cooperative” map back to the digits “3” and “5” respectively, thereby reconstructing the subscriber identification “35.”

To verify the authenticity of the watermark electronic document, the software 204 checks for the universal synonyms that apply to all watermark electronic documents regardless of the subscribers. The verification checks to ensure that the five universal synonyms “contemporary,” “enhancement,” “propelled by,” “transparency,” and “relentless” are present in the text, as depicted in FIG. 8C. If these words are correctly substituted, the watermark electronic document is confirmed to be authentic and properly watermarked by the system. Otherwise, the watermark electronic document is deemed to be inauthentic.

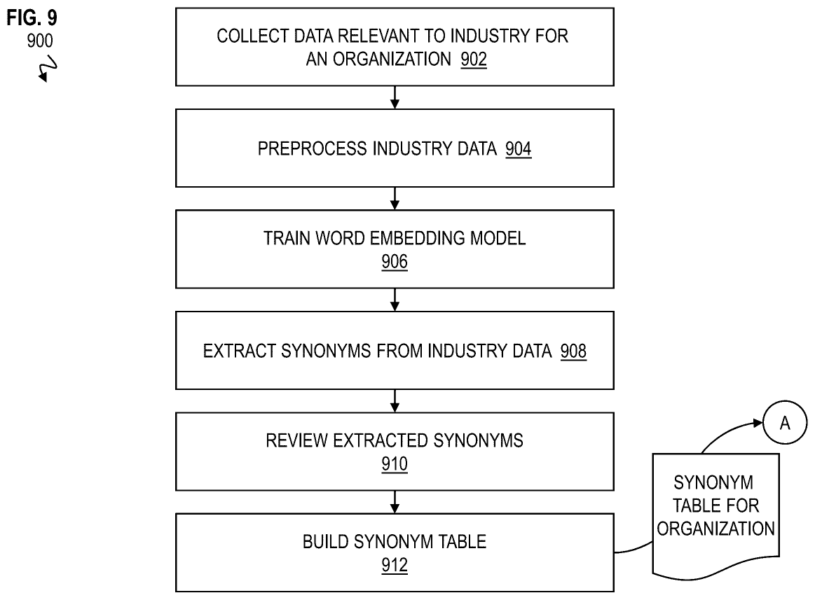

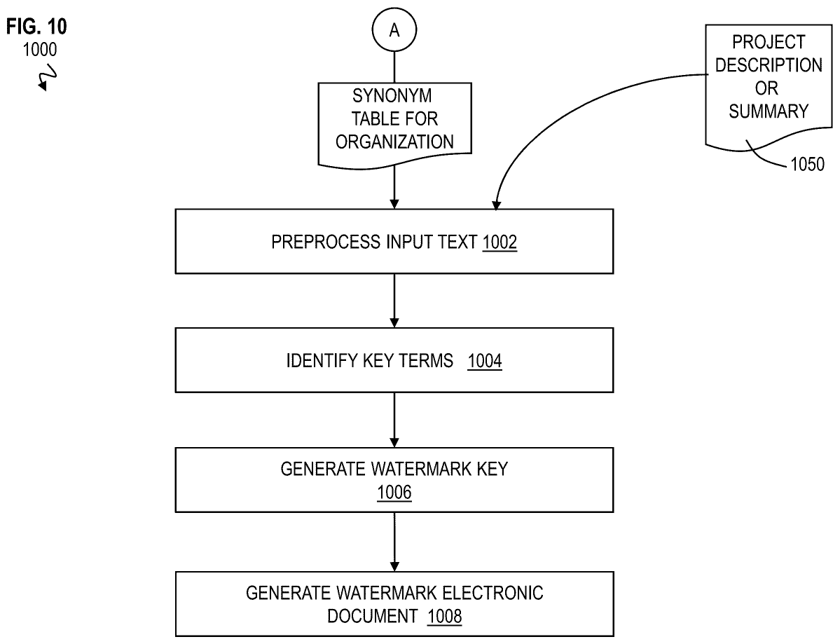

FIGS. 9 and 10 depict an example of constructing a synonym table and generating a watermark key according to one or more embodiments.

Turning to FIG. 9, at block 902, the software 204 is configured to collect data relevant to the industry, for example, for an organization. For instance, this involves collecting industry-specific documents which may include technical manuals, textbook data, etc.

At block 904, the software 204 is configured to preprocess the industry data. This to clean and prepare the text data for analysis. Particularly, the preprocessing removes noise such as special characters, numbers, etc., normalizes text (e.g., lowercasing), and tokenizes the text.

At block 906, the software 204 is configured to train a word embedding model 266. The word embedding model 266 is a machine learning model that is used to understand word relationships within the industry-specific data to create word embeddings. For example, word embedding model 266 could be Word2Vec or a suitable model that is trained on the collected corpus of the industry-specific data in order to create word embeddings. Word embeddings are numerical representations of words, typically as vectors, that capture semantic relationships and contextual information, allowing machines to understand and process language more effectively.

At block 908, the software 204 is configured to extract synonyms from the industry data. This is to identify potential synonyms for key terms using word embeddings. For example, the software 204 can calculate the cosine similarity between word vectors to find the top similar words for each key term in the industry data.

At block 910, the software 204 is configured to provide or send extracted synonyms for review. There can be a review by a subject matter expert (SME) or review by an AI model (e.g., NLP model, LLM, etc.) to ensure that the synonyms are contextually appropriate and accurate. In one or more embodiments, subject matter experts or industry experts can review and refine the list of generated synonyms.

At block 912, the software 204 is configured to build the synonym table. The refined synonyms are compiled into a structured table for use in watermarking. This provides a comprehensive table of synonyms tailored to industry's specific needs.

There are many technical benefits of constructing a synonym table for a particular industry or company to be utilized for watermarking. The following benefits highlight the value of constructing a synonym table tailored to a particular industry or company, ensuring that watermarking efforts are not only effective but also aligned with the specific needs and language of the organization.
1) Enhanced Relevance and Accuracy. Industry-specific context: by focusing on documents and terminology specific to an industry or company, the synonym table ensures that the generated synonyms are contextually accurate and relevant. Improved precision: this reduces the likelihood of incorrect or inappropriate substitutions by considering the unique language and jargon of the industry.
2) Consistency Across Watermark Electronic Documents. Standardization: a tailored synonym table ensures that the same terms are consistently replaced with the same synonyms across all watermark electronic documents, thereby maintaining uniformity. Brand voice preservation: this helps maintain the company's or industry's specific tone and style, which is beneficial for branding and communication consistency.
3) Increased Security in Watermarking. Robust watermarking: custom synonyms make it more difficult for unauthorized parties to detect or reverse-engineer the watermarking process, thereby enhancing document security. Traceability: this ensures that the watermark text can be traced back to its origin, especially when combined with the unique identifier encoding the subscriber identifications.
4) Adaptability and Flexibility. Customizable: the synonym table can be easily updated or expanded to adapt to changes in industry language or company-specific terminology. Versatility: the synonym table can be applied across various types of documents, from reports to contracts, ensuring a wide range of applications.
5) Regulatory and Compliance Support. Regulatory alignment: this helps in adhering to industry-specific regulations and standards by ensuring that watermark electronic documents are compliant with relevant language requirements. Proof of authenticity: a well-constructed synonym table enhances the ability to prove document authenticity and integrity in regulatory or compliance situations.

To generate a watermark key in an automated system based on a specific requirement, such as a project description or a document summary, a structured approach is provided that leverages natural language processing (NLP) techniques and word embeddings. Turning to FIG. 10 as an example of generating watermark keys, at block 1002, the software 204 is configured to preprocess the input text of the project description/document summary 1050 regarding the organization. The project description/document summary 1050 is a summary or description of the original electronic document that is going to be watermarked. The preprocessing can include tokenization for splitting the text into individual words or tokens, stopword removal for removing common stopwords (e.g., stopwords may include works like “the,” “and,” “is,” etc.) that do not add significant meaning, and lemmatization/stemming for reducing words to their base or root form (e.g., from “running” to “run”).

At block 1004, the software 204 is configured to identify key terms in the project description/document summary 1050. Any suitable techniques can be utilized to identify key terms project description/document summary 1050. For keyword extraction, the software 204 can employ NLP techniques such as Term Frequency-Inverse Document Frequency (TF-IDF) or Rapid Automatic Keyword Extraction (RAKE) to identify the most important terms in the text of the project description/document summary 1050 as key terms. As an example, for the project description/document summary 1050, key terms are extracted that are central to the project's scope, objectives, or deliverables.

For synonym identification, pretrained embeddings can be utilized in which pretrained word embeddings such as Word2Vec, GloVe, etc., are used to identify potential synonyms in the synonym table for each key term extracted from the project description/document summary 1050. Cosine similarity can be used to calculate the cosine similarity between the key term's embedding and synonym embedding (e.g., other words in the vocabulary) to find the most similar words.

At block 1006, the software 204 is configured to generate the watermark key from the synonym table. In selecting synonyms for each key term, the software 204 determines and selects the top N similar words based on cosine similarity as potential synonyms for the watermark key. Optionally, the top N selected synonyms can be filtered by context, such that synonyms that do not fit the context of the project description/document summary 1050 can be removed, by checking their usage in similar contexts in the training corpus. In one or more embodiments, an algorithm can be employed for automatically selecting the most contextually appropriate synonym for each key term. This selection can be based on additional criteria such as word frequency, part of speech, or domain-specific relevance.

Once the synonyms are selected, the software 204 creates the watermark key by mapping each key term to its selected synonym thereby forming a key-value pair (e.g., [objective, aim] key-value pair) and storing these key-value pairs in a structured format (e.g., JavaScript Object Notation (JSON), comma-separate values (CSV), etc.) as the watermark key.

At block 1008, the software 204 is configured to apply the watermark key to the original electronic document in order to generate the watermark electronic document. The key terms in the original electronic document are automatically replaced with their corresponding synonyms from the watermark key using an AI model. In one or more embodiments, an AI model can be instructed to check/ensure that the replacement does not alter the original meaning of the text. Accordingly, the final watermark electronic document is produced where specific key terms have been substituted according to the watermark key.

Various technical solutions and technical effects can be provided by one or more embodiments. The novel approach adds watermarks to text documents by leveraging synonym substitution, where an LLM is employed to generate contextually appropriate synonyms for specific words within the text, thereby embedding a unique watermark that can be traced back to the original source. Embodiments further provide an innovative technique of embedding a subscriber identification into the watermark text. The method involves encoding the subscriber identification into the text by systematically replacing specific words with their synonyms, ensuring that the resulting watermark electronic document contains an identifiable pattern that links it to a particular subscriber.

According to one or more embodiments, the novel techniques create customized synonym tables tailored to particular industries or companies and automatically generates watermark keys from these synonym tables. This process involves generating and refining synonyms that are highly relevant to the specific context of a given industry or organization, enhancing the performance and consistency of the watermarking process by ensuring that the synonyms used are both contextually appropriate and domain specific. The automated generation of watermark keys from these synonym tables streamlines the watermarking process, enabling efficient and consistent application across various documents within the same industry or company.

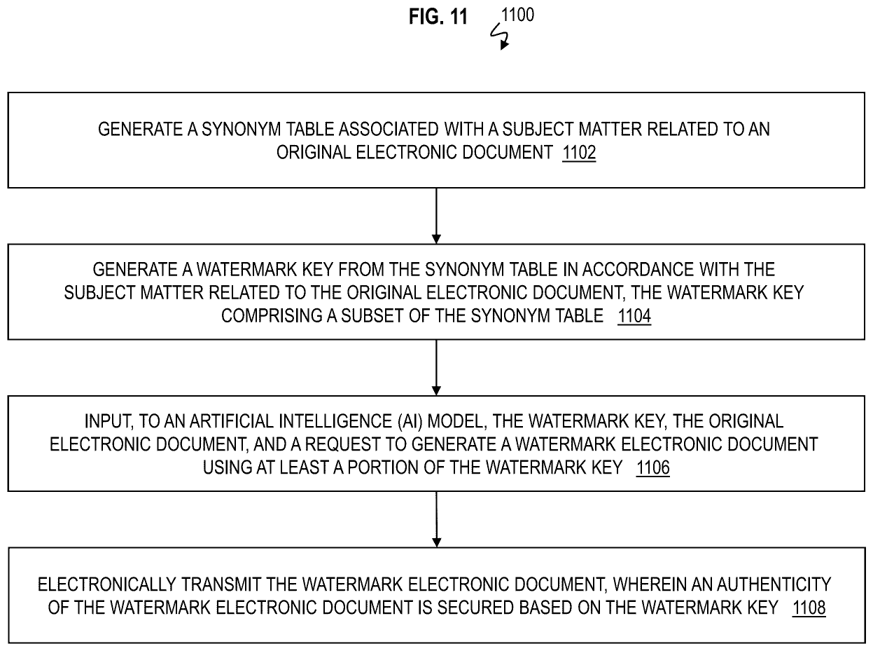

FIG. 11 is a flowchart of a computer-implemented method 1100 for providing AI powered document security using generative AI models for advanced digital watermarking and providing document security actions based on the lack of authenticity and/or improper dissemination of the watermark documents, according to one or more embodiments.

At block 1102, the method 1100 includes generating a synonym table (e.g., synonym table 230) associated with a subject matter related to an original electronic document 220. At block 1104, the method 1100 include generating a watermark key 232 from the synonym table 230 in accordance with the subject matter related to the original electronic document 220, the watermark key 232 comprising a subset of the synonym table 230. At block 1106, the method 1100 includes inputting, to an AI model (e.g., AI model 262), the watermark key 232, the original electronic document 220, and a request to generate a watermark electronic document 222 using at least a portion of the watermark key. At block 1108, the method 1100 includes electronically transmitting the watermark electronic document 222, where an authenticity of the watermark electronic document 222 is secured based on the watermark key 232.

Further, the watermark electronic document comprises substitutions (e.g., synonym substitutions) based on the watermark key. The watermark key is utilized to replace original text in the original electronic document with coded text in the watermark key. The method includes, in response to receiving a validation request for the watermark electronic document, performing a security check for the watermark electronic document in which the watermark electronic document is checked against the watermark key for authentication. The method includes, in response to determining that a watermark is present in the watermark electronic document based on the watermark key, validating that the watermark electronic document is authentic. The method includes, in response to determining that a watermark is absent in the watermark electronic document based on the watermark key, determining that the watermark electronic document is invalid.

A subscriber identification is encoded in the watermark electronic document, the subscriber identification identifying a recipient of the watermark electronic document, where the subscriber identification is configured to track a dissemination of the watermark electronic document. The subject matter of the synonym table is for an industry. A second AI model generates word embeddings for the synonyms related to the industry, the second AI model having been trained on a corpus (e.g., the industry-specific data) related to the industry in order to learn relationships specific to the industry. The synonym table is generated by extracting the synonyms based on the word embeddings. Based on identifying key terms in a description (e.g., project description/summary 1050) of the original electronic document, the watermark key is generated by selecting top synonyms of the synonym table having a similarity to the to the key terms. The watermark electronic document is generated by replacing the key terms found in the original electronic document with the top synonyms, thereby creating a watermark in the watermark electronic document.

In one or more embodiments, the AI model 262, the word embedding model 266, etc., can include various engines/classifiers and/or can be implemented on a neural network. The features of the engines/classifiers can be implemented by configuring and arranging the computer system 202 to execute machine learning algorithms. In general, machine learning algorithms, in effect, extract features from received data (e.g., the complete message formed of segmented messages) in order to “classify” the received data. Examples of suitable classifiers include but are not limited to neural networks, support vector machines (SVMs), logistic regression, decision trees, hidden Markov Models (HMMs), etc. The end result of the classifier's operations, i.e., the “classification,” is to predict a class (or label) for the data. The machine learning algorithms apply machine learning techniques to the received data in order to, over time, create/train/update a unique “model.” The learning or training performed by the engines/classifiers can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier. Unsupervised learning can utilize additional learning/training methods including, for example, clustering, neural networks, deep learning, k-nearest neighbors, Bayesian methods, and the like.

In one or more embodiments, the engines/classifiers are implemented as neural networks (or artificial neural networks), which use a connection (synapse) between a pre-neuron and a post-neuron, thus representing the connection weight. Neuromorphic systems are interconnected elements that act as simulated “neurons” and exchange “messages” between each other. Similar to the so-called “plasticity” of synaptic neurotransmitter connections that carry messages between biological neurons, the connections in neuromorphic systems such as neural networks carry electronic messages between simulated neurons, which are provided with numeric weights that correspond to the strength or weakness of a given connection. The weights can be adjusted and tuned based on experience, making neuromorphic systems adaptive to inputs and capable of learning. After being weighted and transformed by a function (i.e., transfer function) determined by the network's designer, the activations of these input neurons are then passed to other downstream neurons, which are often referred to as “hidden” neurons. This process is repeated until an output neuron is activated. Thus, the activated output neuron determines (or “learns”) and provides an output or inference regarding the input.

Training datasets can be utilized to train the machine learning algorithms. The training datasets can include historical data and the respective labels, as part of supervised learning. For the preprocessing, the raw training datasets may be collected and sorted manually. The sorted dataset may be labeled (e.g., using the Amazon Web Services® (AWS®) labeling tool such as Amazon SageMaker® Ground Truth). The training dataset may be divided into training, testing, and validation datasets. Training and validation datasets are used for training and evaluation, while the testing dataset is used after training to test the machine learning model on an unseen dataset. The training dataset may be processed through different data augmentation techniques. Training takes the labeled datasets, base networks, loss functions, and hyperparameters, and once these are all created and compiled, the training of the neural network occurs to eventually result in the trained machine learning model (e.g., trained machine learning algorithms). Once the model is trained, the model (including the adjusted weights) is saved to a file for deployment and/or further testing on the test dataset.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 12, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 12 are intended to be illustrative only and that computing nodes 10 and cloud computing environment 50 can communicate with any type of computerized device over any type of network and/or network addressable connection (e.g., using a web browser).

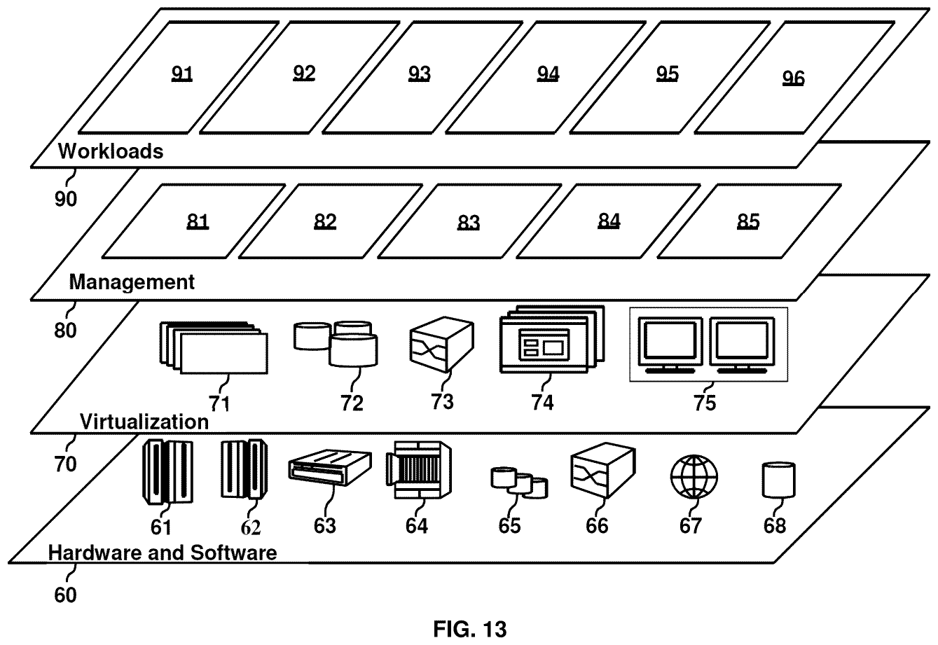

Referring now to FIG. 13, a set of functional abstraction layers provided by cloud computing environment 50 (depicted in FIG. 12) is shown. It should be understood in advance that the components, layers, and functions shown in FIG. 13 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96. One or more aspects of embodiments may be executed, at least in part, by workloads and functions 96. In one or more embodiments, the software 204, the AI model 262, NLP model 264, word embedding model 266, etc., can utilize, be executed as, and/or be integrated with workloads and functions 96.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
generating a synonym table associated with a subject matter related to an original electronic document;
generating a watermark key from the synonym table in accordance with the subject matter related to the original electronic document, the watermark key comprising a subset of the synonym table;
inputting, to an artificial intelligence (AI) model, the watermark key, the original electronic document, and a request to generate a watermark electronic document using at least a portion of the watermark key; and
electronically transmitting the watermark electronic document, wherein an authenticity of the watermark electronic document is secured based on the watermark key.

2. The computer-implemented method of claim 1, wherein the watermark electronic document comprises substitutions based on the watermark key.

3. The computer-implemented method of claim 1, wherein the watermark key is utilized to replace original text in the original electronic document with coded text in the watermark key.

4. The computer-implemented method of claim 1, further comprising, in response to receiving a validation request for the watermark electronic document, performing a security check for the watermark electronic document in which the watermark electronic document is checked against the watermark key for authentication.

5. The computer-implemented method of claim 4, further comprising, in response to determining that a watermark is present in the watermark electronic document based on the watermark key, validating that the watermark electronic document is authentic.

6. The computer-implemented method of claim 4, further comprising, in response to determining that a watermark is absent in the watermark electronic document based on the watermark key, determining that the watermark electronic document is invalid.

7. The computer-implemented method of claim 1, wherein a subscriber identification is encoded in the watermark electronic document, the subscriber identification identifying a recipient of the watermark electronic document, wherein the subscriber identification is configured to track a dissemination of the watermark electronic document.

8. The computer-implemented method of claim 1, wherein:
the subject matter of the synonym table is for an industry;
a second AI model generates word embeddings for synonyms related to the industry, the second AI model having been trained on a corpus related to the industry in order to learn relationships specific to the industry;
the synonym table is generated by extracting the synonyms based on the word embeddings;
based on identifying key terms in a description of the original electronic document, the watermark key is generated by selecting top synonyms of the synonym table having a similarity to the to the key terms; and
the watermark electronic document is generated by replacing the key terms found in the original electronic document with the top synonyms, thereby creating a watermark in the watermark electronic document.

9. A system comprising:
a memory having computer readable instructions; and
one or more processors for executing the computer readable instructions, the computer readable instructions when executed cause the one or more processors to perform operations comprising:
generating a synonym table associated with a subject matter related to an original electronic document;
generating a watermark key from the synonym table in accordance with the subject matter related to the original electronic document, the watermark key comprising a subset of the synonym table;
inputting, to an artificial intelligence (AI) model, the watermark key, the original electronic document, and a request to generate a watermark electronic document using at least a portion of the watermark key; and
electronically transmitting the watermark electronic document, wherein an authenticity of the watermark electronic document is secured based on the watermark key.

10. The system of claim 9, wherein the watermark electronic document comprises substitutions based on the watermark key.

11. The system of claim 9, wherein the watermark key is utilized to replace original text in the original electronic document with coded text in the watermark key.

12. The system of claim 9, wherein the one or more processors perform the operations further comprising, in response to receiving a validation request for the watermark electronic document, performing a security check for the watermark electronic document in which the watermark electronic document is checked against the watermark key for authentication.

13. The system of claim 12, wherein the one or more processors perform the operations further comprising, in response to determining that a watermark is present in the watermark electronic document based on the watermark key, validating that the watermark electronic document is authentic.

14. The system of claim 12, wherein the one or more processors perform the operations further comprising, in response to determining that a watermark is absent in the watermark electronic document based on the watermark key, determining that the watermark electronic document is invalid.

15. The system of claim 9, wherein a subscriber identification is encoded in the watermark electronic document, the subscriber identification identifying a recipient of the watermark electronic document, wherein the subscriber identification is configured to track a dissemination of the watermark electronic document.

16. The system of claim 9, wherein:
the subject matter of the synonym table is for an industry;
a second AI model generates word embeddings for synonyms related to the industry, the second AI model having been trained on a corpus related to the industry in order to learn relationships specific to the industry;
the synonym table is generated by extracting the synonyms based on the word embeddings;
based on identifying key terms in a description of the original electronic document, the watermark key is generated by selecting top synonyms of the synonym table having a similarity to the to the key terms; and
the watermark electronic document is generated by replacing the key terms found in the original electronic document with the top synonyms, thereby creating a watermark in the watermark electronic document.

17. A computer program product comprising a computer readable storage medium having program instructions embodied therewith, the program instructions executable by one or more processors to cause the one or more processors to perform operations comprising:
generating a synonym table associated with a subject matter related to an original electronic document;
generating a watermark key from the synonym table in accordance with the subject matter related to the original electronic document, the watermark key comprising a subset of the synonym table;
inputting, to an artificial intelligence (AI) model, the watermark key, the original electronic document, and a request to generate a watermark electronic document using at least a portion of the watermark key; and
electronically transmitting the watermark electronic document, wherein an authenticity of the watermark electronic document is secured based on the watermark key.

18. The computer program product of claim 17, wherein the watermark electronic document comprises substitutions based on the watermark key.

19. The program product of claim 17, wherein the watermark key is utilized to replace original text in the original electronic document with coded text in the watermark key.

20. The program product of claim 17, further comprising, in response to receiving a validation request for the watermark electronic document, performing a security check for the watermark electronic document in which the watermark electronic document is checked against the watermark key for authentication.
